(19) United States
(12) Patent Application Publication
(10) Pub. No.: US 2004/0254925 A1
(43) Pub. Date: Dec. 16, 2004

(54) Configurable interface

(76) Inventor: James Clough, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/461,808

(22) Filed: Jun. 13, 2003

(51) Int. Cl. G06F 17/30

(52) U.S. Cl. 707/4

(57) ABSTRACT

A computer program for configuring an interface. A computer readable medium storing the program includes instructions for presenting a configuration interface with a user accessible control for entering a link parameter. The medium also includes instructions for configuring a link in a main interface according to the link parameter entered through the configuration interface, and presenting, over a network, the main interface configured according to the link parameter.

### BACKGROUND

Printing solutions developed for venues such as hotels and coffee shops provide customers with access to shared printers. A venue can set its own printing policies and implement its own printing related services. For example, a hotel may have a policy to charge its customers five cents for each page printed. The hotel may provide a service that allows a customer to specify that printed documents are to be delivered to the customer's room or held at the front desk to be picked up.

A shared printer can include an embedded web server that allows venue customers to access one or more embedded web pages. These pages are a natural source for providing venue customers with access to venue specific printing information, policies, and services. However, this poses a strategic problem for the manufacturer of the shared printer. Each venue will have its own unique printing policies and services making it difficult, if not impossible, for the manufacturer to configure embedded web pages that will satisfy the needs of all venues.

The manufacturer could make the embedded web pages customizable, allowing a given venue to add its policies and print services to the embedded web pages. However, the minimal processing power and memory available to a printer make this an unattractive solution. The manufacturer could provide a link in an embedded web page to a policy web site hosted by the manufacturer. The policy website could contain generic policies that may or may not apply to a given venue, and thus fails to provide venue customers with useful information. For example, a policy page hosted by the manufacturer could only state that the user may or may not be charged for printing and that the user may or may not be able to choose to have printed documents delivered.

Consequently, there is a need for a solution that will allow venue customers to access venue specific information, policies, and services through embedded web pages supplied by the manufacturer of a network device such as a printer.

### DESCRIPTION OF THE DRAWINGS

FIG. 1 illustrates an exemplary network in which embodiments of the present invention can be implemented.

FIG. 2 is a schematic representation of the programming elements operating on the devices of FIG. 1 according to an embodiment of the present invention.

FIG. 3 is a schematic representation of device served components according to an embodiment of the present invention.

FIG. 4 is an exemplary screen view of a configuration interface according to an embodiment of the present invention.

FIG. 5 shows an exemplary screen view of a main interface and a number of implementation interfaces according to an embodiment of the present invention.

### DETAILED DESCRIPTION

Glossary:

Program: An organized list of electronic instructions that, when executed, causes a device to behave in a predetermined manner. A program can take many forms. For example, it may be software stored on a computer's disk drive. It may be firmware written onto read-only memory. It may be embodied in hardware as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components.

Client—Server: A model of interaction between two programs. For example, a program operating on one network device sends a request to a program operating on another network device and waits for a response. The requesting program is referred to as the “client” while the device on which the client operates is referred to as the “client device.” The responding program is referred to as the “server,” while the device on which the server operates is referred to as the “server device.” The server is responsible for acting on the client request and returning the requested information, if any, back to the client. This requested information may be an electronic file such as a word processing document or spread sheet, a web page, or any other electronic data to be displayed or used by the client. In any given network there may be multiple clients and multiple servers. A single device may contain programming allowing it to operate both as a client device and as a server device. Moreover, a client and a server may both operate on the same device.

Web Server: A server that implements HTTP (Hypertext Transport Protocol). A web server can host a web site or a web service or both. A web site provides a user interface by supplying web pages to a requesting client, in this case a web browser. Web pages can be delivered in a number of formats including, but not limited to, HTML (Hyper-Text Markup Language) and XML (extensible Markup Language). Web pages may be generated on demand using server side scripting technologies including, but not limited to, ASP (Active Server Pages) and JSP (Java Server Pages). A web page is typically accessed through a network address. The network address can take the form of an URL (Uniform Resource Locator), IP (Internet Protocol) address, or any other unique addressing mechanism. A web service provides a programmatic interface that may be exposed using a variety of protocols layered on top of HTTP, such as SOAP (Simple Object Access Protocol).

Interface: The junction between a user and a computer program providing commands or menus through which a user communicates with the program. The term user in this context represents generally any individual, mechanism, or other program desiring to communicate with the program. For example, in the client-server model defined above, the server usually generates and delivers to a client an interface for communicating with a program operating on or controlled by the server device. Where the server is a web server, the interface can be a web page, a programmatic interface supplied by a web service, or both. A web page, when displayed by the client device, presents a user with controls for selecting options, issuing commands, and entering text. The controls displayed can take many forms. They may include links, push-buttons, radio buttons, text boxes, scroll bars, or pull-down menus accessible using a keyboard and/or a pointing device such as a mouse connected to a client device. In a non-graphical environment, the controls may include command lines allowing the user to enter textual commands.

Link: A user accessible component of an interface that references another interface or other object. Examples of other objects include programs and program files such as a desktop publishing application, a multimedia application, and application files. A link when selected directs a user to the referenced interface or object. Where, for example, an interface is a web page, a link may be a hyper-link referencing another web page.

Network Device: A device equipped to be accessed remotely over a network. Common examples include printers, scanners, and routers. However, other common household appliances such as refrigerators, microwaves, televisions, stereos, and home security systems can be network devices if properly equipped.

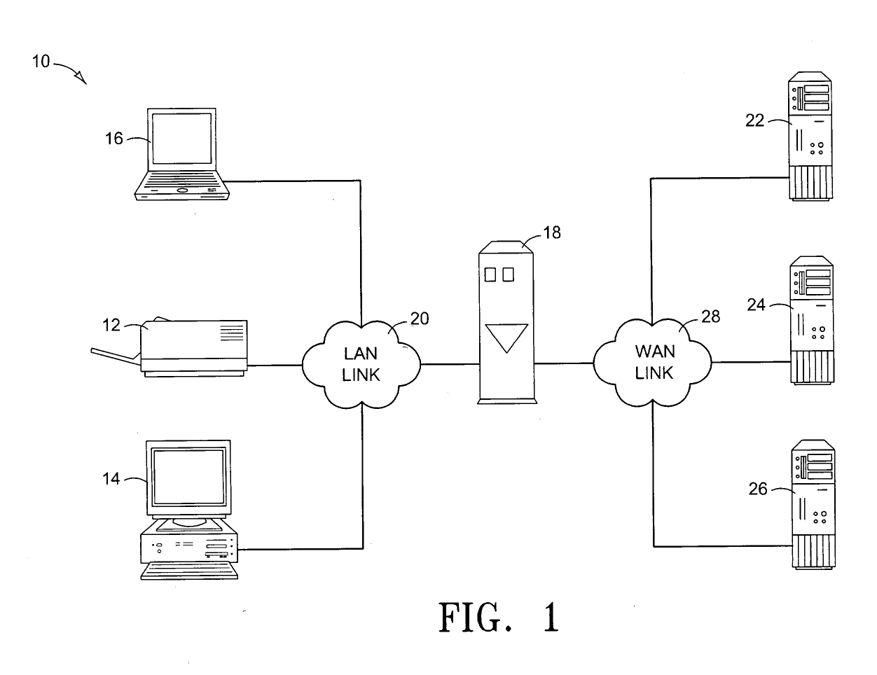

INTRODUCTION: Embodiments of the present invention will allow a web page or other interface served by a network device to be configured to provide a user of the device with access to information and services specific to the device and/or specific to the environment in which the device is operating. FIG. 1 illustrates an exemplary network 10 in which various embodiments of the present invention may be implemented. Network 10 includes network device 12, computers 14 and 16, and broadband server 18. These are referred to collectively as venue components 12-18.

While network device 12 is shown as a printer, network device 12 may be any device equipped to communicate over network 10. Similarly, computers 14 and 16 can be any type of computing devices equipped to communicate over network 10. Broadband server 18 represents generally any combination of hardware and programming capable of limiting communication between the other venue components 12-16 and external components. Broadband server 18 provides a two-way firewall that provides limits on the ability of components 12-16 to access external components of network 10 as well as limiting the ability of external network components from accessing venue components 12-16. Venue components 12-18 are inter-connected by local area network (LAN) link 20. LAN link 20 represents generally any cable, wireless, or remote connection via a telecommunication link, an infrared link, a radio frequency link, or any other connector or system that provides electronic communication between components 12-18.

Network 10 also includes remote locations 22-26 which also represent computing devices equipped to communicate over network 10. For example, remote locations 22-26 may be computers hosting web sites and/or web services. Remote locations 22-26 are interconnected with venue components 12-18 by wide area network (WAN) link 28. WAN link 28 represents generally any cable, wireless, or remote connection via a telecommunication link, an infrared link, a radio frequency link, or any other connector or system that provides electronic communication between remote locations 22-26 and venue components 12-18. WAN Link 28 may include the Internet and/or one or more intranets.

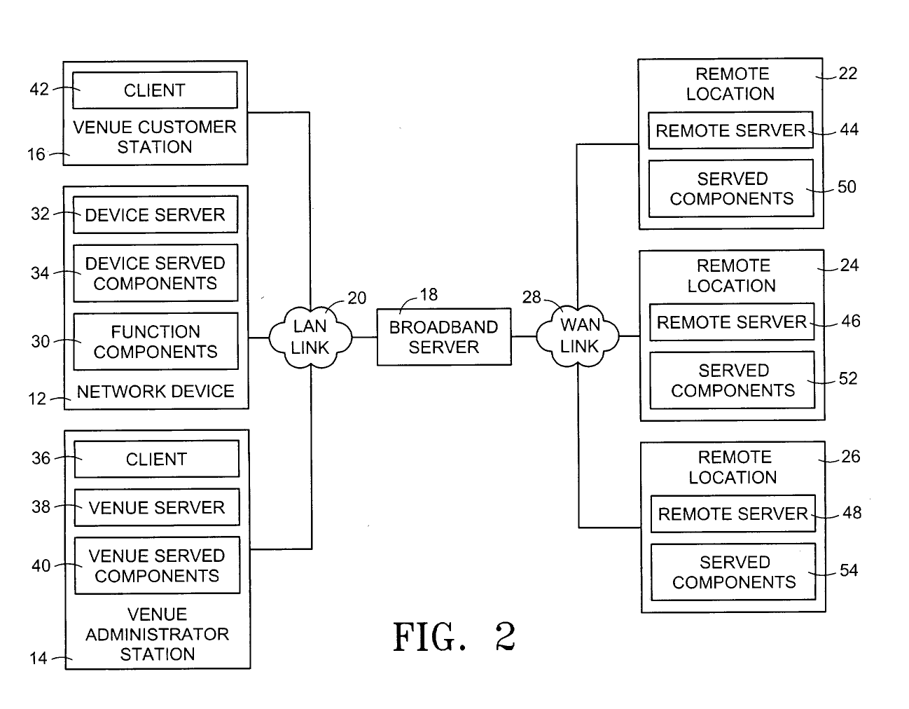

COMPONENTS: FIG. 2 is a schematic representation of network 10 illustrating the programming elements operating on venue components 12-16 and remote locations 22-26. Network device 12 includes functional components 30, device server 32, and device served components 34. Functional components 30 represent the hardware and/or programming for performing the functions for which network device 12 is intended. For example, where network device 12 is a printer or other image forming device, functional components 30 are those components responsible for producing a printed image on paper or other print media. Where network device 12 is a refrigerator, functional components 30 are those components responsible for keeping food cold.

Device server 32 represents generally any programming capable of presenting an interface and/or services in response to requests from computers 14 and 16. Device served components 34 are the interface(s) and/or service(s) presented by device server 32 in response to requests from computers 12 and 14. Presenting an interface or service involves making the interface or service available to a device such as computer 14 or 16 so that it can be displayed or used. Where for example, an interface is a web page, presenting the web page can involve sending the web page to computer 14 or 16 to be displayed by a browser. Presenting a service can involve exposing a programmatic interface allowing communication between the service and an application such as a web browser extension running on computer 14 or 16.

In FIG. 2, computer 14 is labeled venue administrator station 14 and includes, among other programming not shown, client 36, venue server 38, and venue served components 40. Client 36 represents generally any programming capable of making requests of a server such as device server 32, venue server 38, and remote servers 44-48. Where device server 32 is a web server, client 36 can be a web browser. Venue server 38 represents generally any programming capable of presenting interfaces and services in response to requests from computer 16. Venue served components 40 are the interface(s) and/or service(s) presented by venue server 38 in response to requests from computer 16.

Remote locations 22-26 include remote servers 44-48 and remote served components 50-54. Remote servers 44-48 represent generally any programming capable of presenting interfaces and services in response to requests from computers 14 and 16. Remote served components 50-54 are the interface(s) and/or service(s) presented by remote servers 44-48 in response to requests from computers 12 and 14.

It is noted that network 10 can include more than one network device 12, more than one venue station 16, and more than one venue administrator station 14. The modifying terms “remote,” “device,” “venue,” “customer,” and “administrator” are meant only to help the reader distinguish a particular component from the other components of network 10.

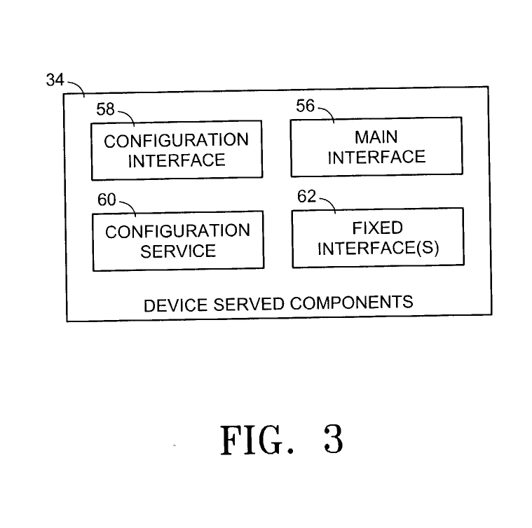

Referring now to FIG. 3, device served components 34 include main interface 56, configuration interface 58, configuration service 60, and fixed interface(s) 62. While main interface 56 can represent generally any type of interface, in the embodiments discussed here, main interface 56 represents a user interface providing user access to information regarding network device 12 and/or access to services relating to the functions of network device 12. For example, where network device 12 is a printer or other image forming device, main interface 56 could provide information about the printer and/or access to printing related services. Printing related services could be services that enable remote configuration of print settings as well as services directly related to printing a document.

Configuration interface 58 represents any interface through which one or more configuration parameters can be entered. A configuration parameter is data that can be used to directly or-indirectly configure main interface 56. For example, configuration interface 58 can be a web page with user accessible controls for entering configuration parameters. Parameters entered through configuration interface 58 can be link parameters used to configure a link to be included in main interface 56. A link parameter is a parameter relating to the inclusion of or to a state of a link. A link parameter can specify a network address for the link to reference—a link reference. It can identify a link image. A link image is a control displayed in an interface like main interface 56 that when selected directs a user to a particular network address referenced by the link. A link parameter can also be a link descriptor. A link descriptor is text or other data associated with a link. A link parameter can also specify whether a particular link is to be made available or used.

Configuration service 60 represents generally any programming capable of acquiring configuration parameters entered through configuration interface 58 and using those parameters to configure main interface 56. Configuring main interface 56 can involve generating a new main interface 56 or modifying an existing main interface 56.

In operation, device server 32 supplies configuration interface 58 to client 36. Client 36 displays configuration interface 58 allowing a user to enter one or more configuration parameters. Configuration parameters are then returned to network device 12. Where network device 12 is equipped to display a user interface network device 12 may, alternatively, display configuration interface 58. Configuration parameters can then be entered through a keypad or other input device provided. Configuration parameters, wherever they are entered, are acquired by configuration service 60. Configuration service 60 configures main interface 56 according to those parameters. Upon request from client 42 running on venue station 16, device server 12 supplies the now configured main interface 56. Main interface 56 may be configured, so that when displayed, it includes a control for selecting a defined link. That link may be defined to reference a network address for accessing venue served components 40 or remote served components 50-54.

The modifying terms “configuration” and “main” as they relate to interfaces are used only to distinguish between two interfaces in a given context. Depending upon the context, a main interface may also be a configuration interface and a configuration mage may also be a main interface.

The block diagrams of FIGS. 2-3 show the architecture, functionality, and operation of various embodiments of the present invention. Each block may represent in whole or in part a module, segment, or portion of code that comprises one or more executable instructions to implement the specified logical function(s). Each block may represent a circuit or a number of interconnected circuits to implement the specified logical function(s).

Also, the present invention can be embodied in any computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any media that can contain, store, or maintain programs and data for use by or in connection with the instruction execution system. Computer readable media can comprise any one of many physical media such as, for example, electronic, magnetic, optical, electromagnetic, infrared, or semiconductor media. More specific examples of suitable computer-readable media include, but are not limited to, a portable magnetic computer diskette such as floppy diskettes or hard drives, a random access memory (RAM), a read-only memory (ROM), an erasable programmable read-only memory, or a portable compact disc.

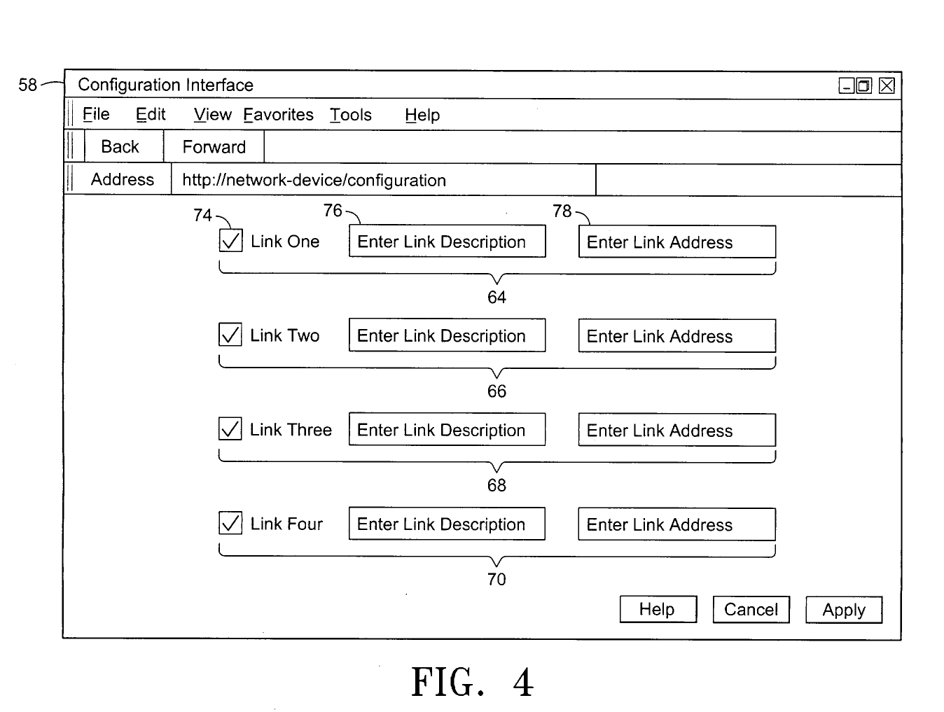

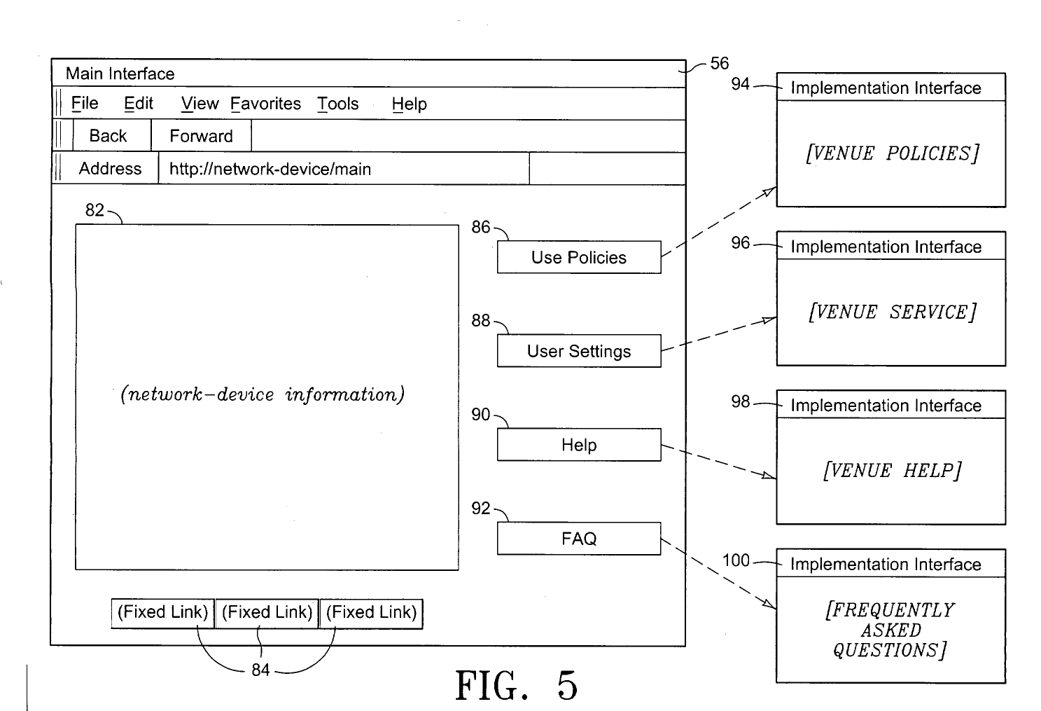

EXAMPLES: FIGS. 4 and 5 are exemplary screen views of interfaces 56 and 58. In the example of FIG. 4, configuration interface 58 is shown as a web page for configuring links in main interface 56. Configuration interface 58 includes parameter control groups 64-70. Each parameter control group 64-70 includes a set of parameter controls 74-78 for entering parameters for configuring a link in main interface 56. Parameter control 74 is check box, that when selected dictates that a link identified as “Link One” is to be included or activated in main interface 56. Link control 75 is a text box in which a description of “Link One” can be entered. Link control 78 is a text box in which a network address to be referenced by “Link One” can be entered.

While configuration interface 58 is shown to include four parameter control groups 64-70, it could include more or less. The number included merely determines the number of links that can be configured in main interface 56. Each parameter control group 64-70 can include any number of parameter controls. Moreover, the parameter controls for each group may be different. It is noted that configuration interface can be designed differently to serve different purposes relating to the configuration of main interface 56. For example, configuration interface 58 may include one or more controls for identifying images and/or text that are not related to a link but are to be displayed in main interface 56.

FIG. 5 illustrates an example of main interface 56 that has been configured through configuration interface 58 of FIG. 4. Main interface 56 includes information section 82, fixed links 84, and configurable links 86-92. Information section 82 represents a section of main interface 56 used to display general information relating to network device 12. General information can, for example, include a description of network device 12 or other data provided by a manufacturer. Fixed links 84 represent links that are not configured through configuration interface 58. One or more of fixed links 84 may reference network addresses associated with fixed interfaces 62 hosted by network device. A fixed link may also reference a network address for accessing an interface supplied by the manufacturer of network device 12.

Configurable Links 86-92 have been configured to reference network addresses for implementation interfaces 94-100. An implementation interface is any interface providing venue specific information relating to the use of network device 12. Where network device 12 is a printer or other image forming device, this information can include printer location, price per page and, pickup policies. An implementation interface can also provide a user interface for accessing or interacting with venue specific services relating to the use of the image forming device. Such a service may allow, for example, a hotel customer to indicate that printed documents are to be delivered to the customer's room.

In the example of FIG. 5, configurable link 86 has been configured to reference a network address for an interface that displays use policies for network device 12. When configurable link 86 is selected, the user is directed to interface 94 displaying policies specific to the venue in which network device 12 is located. With reference back to FIG. 2, interface 94 may be part of remote served components 50 of remote location 22. Configurable link 88 has been configured to reference a network address for an interface that enables a user to interact with a venue service relating to the use of network device 12. When configurable link 88 is selected, the user is directed to interface 96 displaying information and any user accessible controls needed to interact with the venue service. With reference back to FIG. 2, interface 96 may, for example, be part venue served components 40 of venue administrator station 14.

Configurable link 90 has been configured to reference a network address for a help interface specific to the venue in which network device 12 is located. When configurable link 90 is selected, the user is directed to venue help interface 98. With reference back to FIG. 2, interface 98 may be part of remote served components 52 of remote location 24. Configurable link 92 has been configured to reference a network address for a FAQ (Frequently Asked Questions) interface specific to the venue in which network device 12 is located. With reference back to FIG. 2, interface 98 may be part of remote served components 54 of remote location 26.

CONCLUSION: The present invention has been shown and described with reference to the foregoing exemplary embodiments. It is to be understood, however, that other forms, details, and embodiments may be made without departing from the spirit and scope of the invention which is defined in the following claims.

What is claimed is:

1. A computer readable medium having instructions for presenting a configuration interface with a user accessible control for entering a link parameter, configuring a main interface according to the link parameter entered through the configuration interface, and presenting, over a network, the main interface configured according to the link parameter.

2. The medium of claim 1, wherein the instructions for presenting a configuration interface comprise instructions for presenting a configuration interface having user accessible controls for entering a plurality of link parameters, and the instructions for configuring comprise configuring a main interface according to one or more link parameters entered through the configuration interface.

3. The medium of claim 1, wherein the instructions for presenting a configuration interface comprise instructions for presenting a configuration interface having one or more user accessible controls selected from a group consisting of a control for identifying a link reference, a control for entering a link descriptor, and a control for identifying a link image.

4. The medium of claim 1, wherein the instructions for presenting a configuration interface comprise instructions for presenting the configuration interface over the network.

5. A computer readable medium embedded in a network device, the medium having instructions for:
presenting a configuration interface having a user accessible control for entering a configuration parameter;
configuring a link in a main interface according to the configuration parameter entered through the configuration interface; and
presenting the main interface containing the link configured according to the configuration parameter.

6. The medium of claim 5, wherein the instructions for presenting a configuration interface comprise instructions for presenting a configuration interface having user accessible controls for entering a plurality of configuration parameters, and the instructions for configuring comprise configuring a plurality of links in the main interface according to one or more configuration parameters entered through the configuration interface.

7. A computer readable medium embedded in a network device, the medium having instructions for presenting a configuration interface having a user accessible control for entering a link parameter, and configuring a link in a main interface for the network device according to the link parameter entered through the configuration interface.

8. The medium of claim 7, wherein the instructions for presenting a configuration interface comprise instructions for presenting a configuration interface having user accessible controls for entering a plurality of link parameters, and the instructions for configuring comprise configuring a plurality of links in the main interface according to one or more link parameters entered through the configuration interface.

9. A web service, comprising:
a server operable to present, over a network, a main interface and a configuration interface that includes a user accessible control for entering a link parameter; and
a configuration module, in communication with the server, operable to acquire a link parameter entered through the configuration interface and configure a link of the main interface according to the link parameter.

10. The web service of claim 9, wherein the configuration interface includes user accessible controls for entering a plurality of link parameters and the configuration module is operable to acquire link parameters entered through the configuration interface and to configure the main interface according to one or more of the link parameters.

11. The web service of claim 9, wherein the configuration interface includes one or more user accessible controls selected from a group consisting of a control for identifying a link reference, a control for entering a link descriptor, and a control for identifying a link image.

12. A web service embedded in a network device, the web service comprising:
a server operable to present a main interface for the network device and a configuration interface including a user accessible control for entering a configuration parameter; and
a configuration module operable to a acquire a configuration parameter entered through the configuration interface and to configure a link in the main interface according to the configuration parameter.

13. The embedded web service of claim 12, wherein the configuration interface includes user accessible controls for entering a plurality of configuration parameters, and wherein the configuration module is operable to acquire configuration parameters entered through the configuration interface and to configure a plurality of links in the main interface according to one or more of the configuration parameters.

14. A web service embedded in a network device, the web service comprising a server operable to present a configuration interface the includes a user accessible control for entering a link parameter, and a configuration module operable to acquire a link parameter entered through the configuration interface and to configure a link in a main interface for the network device according to the link parameter.

15. The web service of claim 14, wherein the configuration interface includes user accessible controls for entering a plurality of link parameters, and wherein the configuration module is operable to acquire a plurality of link parameters entered through the configuration interface and to configure a plurality of links in the main interface according to one or more of the link parameters.

16. A system comprising: an implementation interface associated with a network address;
a server operable to present a main interface for an image forming device and a configuration interface that includes a user accessible control for entering the network address; and
a configuration module operable to acquire the network address entered through the configuration interface and to configure a link in the main interface to reference the network address.

17. The system of claim 16, wherein the server and the configuration module are components of a web service embedded in the image forming device.

18. The system of claim 16 further comprising one or more additional implementation interfaces, each of the implementation interfaces associated with a different network address, and wherein the configuration interface includes user accessible controls for entering each of the network addresses, and wherein the control module is operable to acquire network addresses entered through the control interface and configure for each network address acquired, a link in the main interface to reference that network address.

19. A web service comprising:
a means for presenting a configuration interface with a user accessible control for entering a link parameter;
a means for configuring a link in a main interface according to the link parameter entered through the configuration interface; and
a means for presenting, over a network, the main interface containing the link configured according to the link parameter.

20. The web service of claim 19 wherein the means for presenting a configuration interface includes a means for presenting a configuration interface with one or more user accessible controls selected from a group consisting of a control for identifying a link reference, a control for entering a link descriptor, and a control for identifying a link.
